(19) United States
(12) Patent Application Publication
(10) Pub. No.: US 2012/0081813 A1
(43) Pub. Date: Apr. 5, 2012

(54) WIRING STRUCTURE, DATA RECORDING DEVICE, AND ELECTRONIC APPARATUS

(75) Inventors: Toru EZAWA, Tokyo (JP); Tomokazu Okubo, Tokyo (JP)

(73) Assignee: Kabushiki Kaisha Toshiba, Tokyo (JP)

(21) Appl. No.: 13/216,593

(22) Filed: Aug. 24, 2011

(30) Foreign Application Priority Data
Sep. 30, 2010 (JP) P2010-223215

(51) Int. Cl. G11B 5/265; H01B 5/08

(52) U.S. Cl. 360/121; 174/128.1; G9B/5.068

(57) ABSTRACT

A wiring structure includes: positive signal wires configured to transmit a positive signal of differential signals; and negative signal wires configured to transmit a negative signal of the differential signals. The positive signal wires and the negative signal wires are interleaved. A first gap length and a second gap length are different from each other where the first gap length is a gap length between a first wire being an outermost wire among the positive signal wires and the negative signal wires and a first adjacent wire that is adjacent to the first wire, where the second gap length is a gap length between a second wire that is located inside among the positive signal wires and the negative signal wires and a second adjacent wire that is adjacent to the second wire. The second wire and the second adjacent wire are different from the first wire.

### CROSS REFERENCE TO RELATED APPLICATION(S)

The present disclosure relates to the subject matters contained in Japanese Patent Application No. 2010-223215 filed on Sep. 30, 2010, which are incorporated herein by reference in its entirety.

### FIELD

An embodiment of the invention generally relates to a wiring structure which is involved in transmission of differential signals, a data recording device, and an electronic apparatus.

### BACKGROUND

In recent years, the transfer rate of signals that are transmitted in data recording devices as typified by an HDD and electronic apparatus as typified by a PC have increased. The increase in the transfer rate of transmission signals means increase in the frequency band of signals. Signals in high frequency bands on the order of gigahertz, for example, are commonly transmitted as differential signals.

For example, in HDDs, write traces and reader traces which are formed on a suspension transmit differential signals. The term “trace” means a wire. In HDDs having a recording medium (disk) rotation speed of 15,000 rpm, the transfer rate of a signal to be recorded on the disk and a signal that is read from the disk is higher than 3.0 Gbps.

The signal quality degradation due to transmission of a read-out signal is able to be lowered by such techniques as waveform equalization and error correction. However, a recording signal needs to be transmitted while its quality is kept as high as possible because it is recorded on a disk with quality that it has after a transmission.

When the transmission rate (or frequency) of a transmission signal is high, it is necessary to properly set a signal pass bandwidth characteristic of a wiring structure that is involved in transmission of differential signals. In a wiring structure in which a positive signal and a negative signal of differential signals are each transmitted by a single line, it is not easy to set a signal pass bandwidth characteristic properly. In view of this, a wiring structure has come to be employed in which each of a positive signal transmission line and a negative signal transmission line branches off into plural lines at a certain position of traces and positive signal and negative signal branch transmission lines are interleaved (arranged alternately). This wiring structure is also called “interleaved structure.” The interleave wiring structure facilitates impedance control and can thereby improve the signal pass bandwidth characteristic.

### BRIEF DESCRIPTION OF THE DRAWINGS

A general configuration that implements the various feature of the invention will be described with reference to the drawings. The drawings and the associated descriptions are provided to illustrate an embodiment of the invention and not to limit the scope of the invention.

FIG. 1 is an exemplary block diagram showing configuration of a data recording device according to an embodiment.

FIG. 2 is an exemplary schematic perspective view showing the structure of interleaved conductor patterns according to the embodiment.

FIG. 3 is an exemplary sectional view showing a relationship between the gap lengths of the adjoining conductor patterns and the widths of the respective conductor patterns.

FIG. 4 is an exemplary graph of a bandwidth characteristic of transmission lines in which interleaved conductor patterns according to the embodiment are formed according to a first forming condition.

FIG. 5 is an exemplary graph of a bandwidth characteristic of transmission lines in which interleaved conductor patterns according to the embodiment are formed according to a second forming condition.

FIG. 6 is an exemplary perspective view of a notebook personal computer which is an electronic apparatus including the data recording device according to the embodiment.

FIG. 7 is an exemplary perspective view of a notebook personal computer of FIG. 6 which is an electronic apparatus including an FPC having the wiring structure according to the embodiment.

### DETAILED DESCRIPTION OF THE EMBODIMENTS

According to one embodiment, a wiring structure includes: a plurality of positive signal wires configured to transmit a positive signal of differential signals; and a plurality of negative signal wires configured to transmit a negative signal of the differential signals. The plurality of positive signal wires and the plurality of negative signal wires are interleaved. A first gap length and a second gap length are substantially different from each other, where the first gap length is a gap length between a first wire being an outermost wire among the plurality of positive signal wires and the plurality of negative signal wires and a first adjacent wire that is adjacent to the first wire, where the second gap length is a gap length between a second wire that is located inside among the plurality of positive signal wires and the plurality of negative signal wires and a second adjacent wire that is adjacent to the second wire. The second wire and the second adjacent wire are different from the first wire.

An embodiment will be hereinafter described with reference to the drawings.

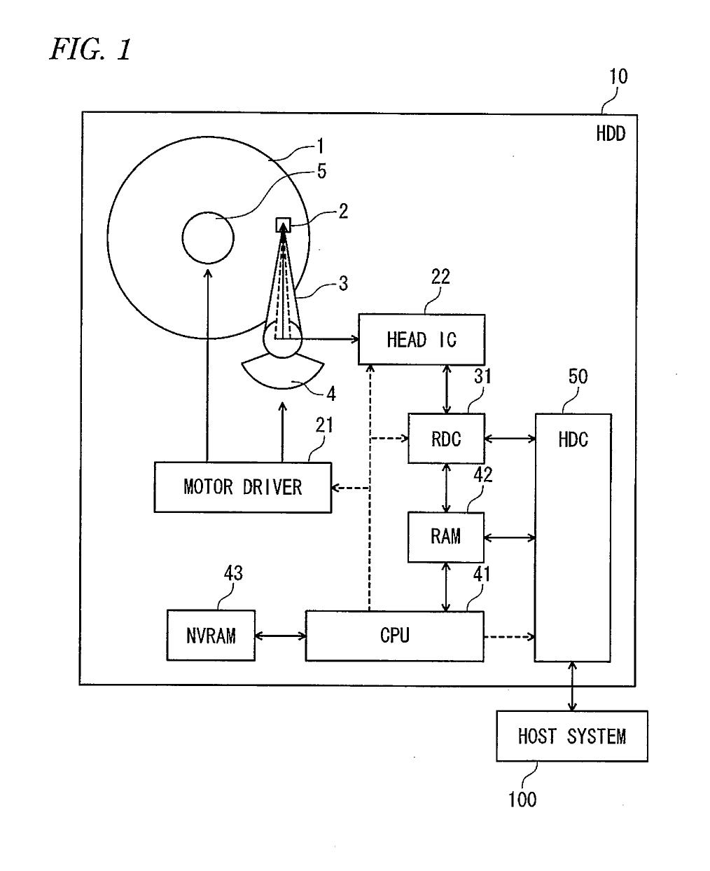

FIG. 1 is an exemplary block diagram showing the configuration of a data recording device (hereinafter also referred to as HDD) 10. The HDD 10 is also an electronic apparatus which communicates with a host system 100.

The HDD 10 according to the embodiment is equipped with mechanism components such as a magnetic disk 1, a slider 2, a suspension 3, a voice coil motor (VCM) 4, and a spindle motor (SPM) 5. The HDD 10 is also equipped with circuit blocks such as a motor driver 21, a head IC 22, a read/write channel IC (hereinafter also referred to as RDC) 31, a CPU 41, a RAM 42, an NVRAM 43, and a hard disk controller (HDC) 50.

In the HDD 10 according to the embodiment, plural conductor patterns for electrically connecting the slider 2 and the head IC 22 are formed on the suspension 3. These conductor patterns are sometimes called traces. In the HDD 10 according to the embodiment, the plural conductor patterns formed on the suspension 3 are transmission lines for differential signals that configures a positive signal and a negative signal. Each of the positive signal transmission line and the negative signal transmission line branches off into plural lines and positive signal and negative signal branch transmission lines are interleaved. This wiring structure may be called “interleaved structure.” The embodiment is directed to interleaved conductor patterns having the characteristic structure.

Fixed to the SPM 5, the magnetic disk 1 is rotated being driven by the SPM 5. At least one side of the magnetic disk 1 is a record side on which information is recorded magnetically.

The slider 2 is provided at one end of the suspension 3 so as to be opposed to the record side of the magnetic disk 1. The slider 2 is provided with a read head and a write head (neither of which is shown). The read head reads a signal that is magnetically recorded on the record side of the magnetic disk 1. The read-out signal is output to the head IC 22 via conductor patterns formed on the suspension 3. The write head magnetically records, on the record side of the magnetic disk 1, in response to a write signal (write current) that is input from the head IC 22 via conductor patterns formed on the suspension 3. The read head and the write head which are provided on the slider are electrically connected to the conductor patterns formed on the suspension 3.

The suspension 3 is provided with the slider 2 at one end and with a bearing module (not shown) at the other end. The suspension 3 is rotated with the bearing module as a rotation center according to a drive current that is supplied to the VCM 4, and thereby moves the slider 2 in the radial direction over the record side of the magnetic disk 1. The suspension 3 is provided with plural conductor patterns on its one side.

The VCM 4 is driven according to a drive signal (current) that is supplied from the motor driver 21, and thereby rotates the suspension 3.

The SPM 5 is driven according to a drive signal (current) that is supplied from the motor driver 21, and thereby rotates the magnetic disk 1.

The motor driver 21 supplies the VCM 4 with a drive signal (current) for driving it and supplies the SPM 5 with a drive signal (current) for driving it under the control of the CPU 41.

The head IC 22 amplifies a signal that is input from the read head of the slider 2 via the conductor patterns formed on the suspension 3, and outputs an amplified signal to the RDC 31 as read information. Furthermore, the head IC 22 outputs a write signal (write current) corresponding to recording information that is input from the RDC 31, to the write head of the slider 2 via the conductor patterns formed on the suspension 3.

The RDC 31 decodes read information that is input from the head IC 22 by performing certain processing on it, and outputs resulting decoded information to the HDC 50. Furthermore, the RDC 31 encodes recording subject information that is input from the HDC 50 by performing certain processing on it, and outputs resulting coded information to the head IC 22 as recording information. The RDC 31 uses the RAM 42 as a work memory in performing the certain processing for encoding or decoding.

The CPU 41 controls the individual blocks of the HDD 10 according to programs stored in the NVRAM 43. The CPU 41 is a processor for controlling operations of rotating the VCM 4 and the SPM 5. The CPU 41 uses the RAM 42 as a work memory in running the programs.

The RAM 42 is a work memory for the RDC 31, the CPU 41, and the HDC 50. The RAM 42 is a DRAM which is a volatile memory.

The NVRAM 43 is a nonvolatile memory for storing programs to be run by the CPU 41. The programs stored in the NVRAM 43 is able to be updated.

The HDC 50 performs communication processing of transmitting and receiving information to and from the host system 100. The HDC 50 encodes decoded information that is input from the RDC 31 by performing prescribed processing on it, and transmits resulting coded information to the host system 100 as transmission information. The HDC 50 decodes reception information received from the host system 100 by performing certain processing on it, and outputs resulting decoded information to the RDC 31 as recording subject information. For example, the HDC 50 performs communication processing that complies with the SATA (serial advanced technology attachment) standard to communicate with the host system 100.

In the above-configured HDD 10 according to the embodiment, information is read from and recorded on the magnetic disk 1 by the plural blocks of the HDD 10. Information that is read from the magnetic disk 1 and information to be recorded on the magnetic disk 1 are each transmitted as an electrical signal via the conductor patterns formed on the suspension 3. In the embodiment, interleaved conductor patterns are applied to at least transmission of an electrical signal of information to be recorded on the magnetic disk 1. This structure makes it possible to configure transmission lines that are suitable for the characteristics of an electrical signal to be transmitted, that is, to properly control the bandwidth characteristic of transmission lines (wires) for an electrical signal.

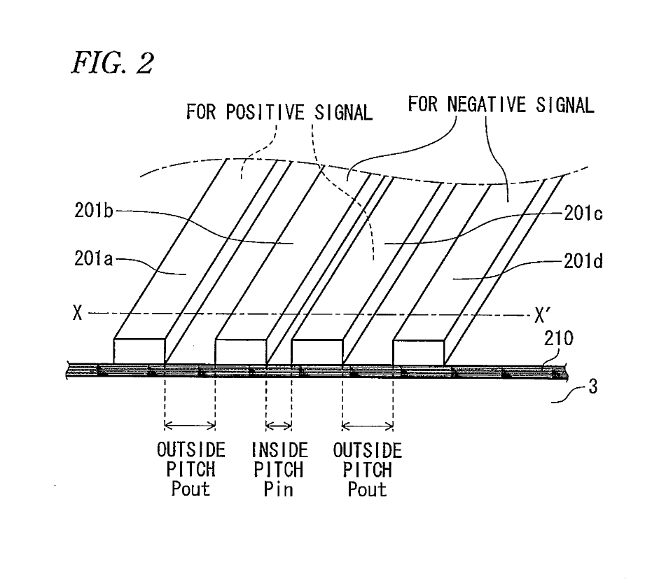

Next, the structure of interleaved conductor patterns according to the embodiment formed on the suspension 3 will be described with reference to FIG. 2. FIG. 2 is an exemplary schematic perspective view showing the structure of interleaved conductor patterns according to the embodiment.

As shown in FIG. 2, in the embodiment, four conductor patterns 201a-201d are formed on one side of the suspension 3 with an insulator layer 210 interposed in between. To protect the conductor patterns 201a-201d, a cover layer (not shown) made of an insulator is formed on the top of parts of the conductor patterns 201a-201d and the insulator layer 210.

In the embodiment, the conductor patterns 201a-201d have the interleaved structure. That is, the four conductor patterns 201a-201d are a positive signal conductor pattern, a negative signal conductor pattern, a positive signal conductor pattern, and a negative signal conductor pattern that are arranged in this order from the left. The leftmost conductor pattern 201a and the third (from the left) conductor pattern 201c transmit the same positive signal. The rightmost conductor pattern 201d and the third (from the right) conductor pattern 201b transmit the same negative signal. By virtue of this interleaved structure, the capacitance component is made smaller than in usual wires for differential signals because of reduction in the total area of the conductor patterns that face the suspension 3 and the inductance component is also made smaller than in usual wires for differential signals because of reduction in the degree of physical interaction between the conductor patterns. As such, the interleaved structure increases the propagation speed of a TEM wave which is defined by \sqrt{(1/CL)}, that is, improves the bandwidth characteristic of the transmission lines.

In the embodiment, the gap lengths between the adjoining conductor patterns are set at certain lengths. For example, in the example of FIG. 2, the gap length (outside pitch) between the conductor patterns 201a and 201b is set equal to the gap length (outside pitch) between the conductor patterns 201c and 201d. The ratio of the outside pitch to the gap length (inside pitch) between the conductor patterns 201b and 201c is set at a certain value. Setting the ratio of the outside pitch to the inside pitch makes it possible to control the capacitance and the inductance of the transmission lines properly, that is, to control the bandwidth characteristic of the transmission lines.

Although in the embodiment each of the positive signal conductor pattern and the negative signal conductor pattern branches off into two conductor patterns, each of the positive signal conductor pattern and the negative signal conductor pattern may branch off into three, four, or more conductor patterns. In this case, the number of positive signal branch conductor patterns and the number of negative signal branch conductor patterns increase with the branching number. The bandwidth of the transmission lines is controlled to a target bandwidth by adjusting the gap lengths of the adjoining conductor patterns to certain lengths. It is preferable that the number of positive signal branch conductor patterns be equal to the number of negative signal branch conductor patterns. Although in the embodiment the positive signal conductor pattern 201a, the negative signal conductor pattern 201b, the positive signal conductor pattern 201c, and the negative signal conductor pattern 201d are arranged in this order from the left, they may be arranged in this order from the right.

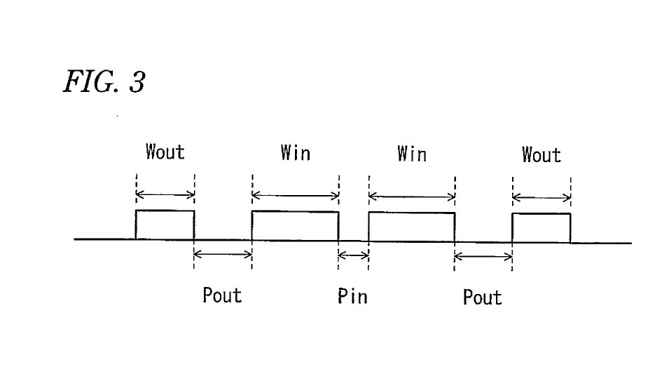

Next, the relationship between the gap lengths of the adjoining conductor patterns and the widths of the respective conductor patterns will be described with reference to FIG. 3. FIG. 3 is an exemplary sectional view showing a relationship between the gap lengths of the adjoining conductor patterns and the widths of the respective conductor patterns.

FIG. 3 is a sectional view taken along line X-X′ in FIG. 2. The outside pitch and the inside pitch that were defined with reference to FIG. 2 are represented by Pout and Pin, respectively. The width of the outside conductor patterns 201a and 201d is represented by Wout and the width of the inside conductor patterns 201b and 201c is represented by Win. The dimensions of Pout, Pin, Wout, and Win have tolerances in manufacture, and it is known that they are about ±10 μm nominally. However, in general, they are actually equal to about ±3μm. That is, the dimensions of Pout, Pin, Wout, and Win have tolerances of about ±3

The relationship between the gap lengths of the adjoining conductor patterns and the widths of the respective conductor patterns will be described below in different terms with reference to FIG. 3. Where the outside conductor patterns 201a and 201d among the conductor patterns 201a-201d are referred to as first wires, the conductor patterns 201b and 201c that are adjacent to the respective first wires are referred to as first adjacent wires. The outside pitch Pout is a first gap length between the adjoining ones of the first wires and the first adjacent wires. Where the inside conductor pattern 201b or 201c among the conductor patterns 201a-201d is referred to as a second wire, the conductor pattern 201c or 201b that is adjacent to the second wire and is not a first wire is referred to as a second adjacent wire. The inside pitch Pin is a second gap length between the second wire and the second adjacent wire. The first gap length is different from the second gap length.

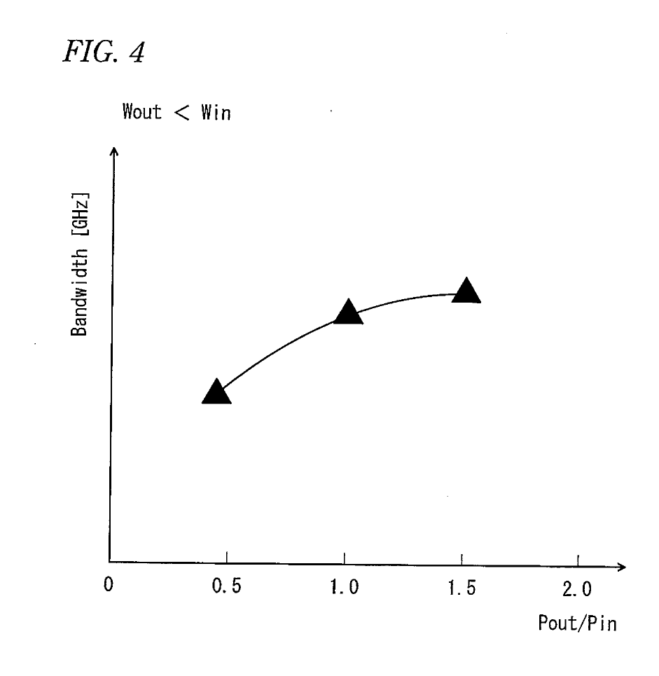

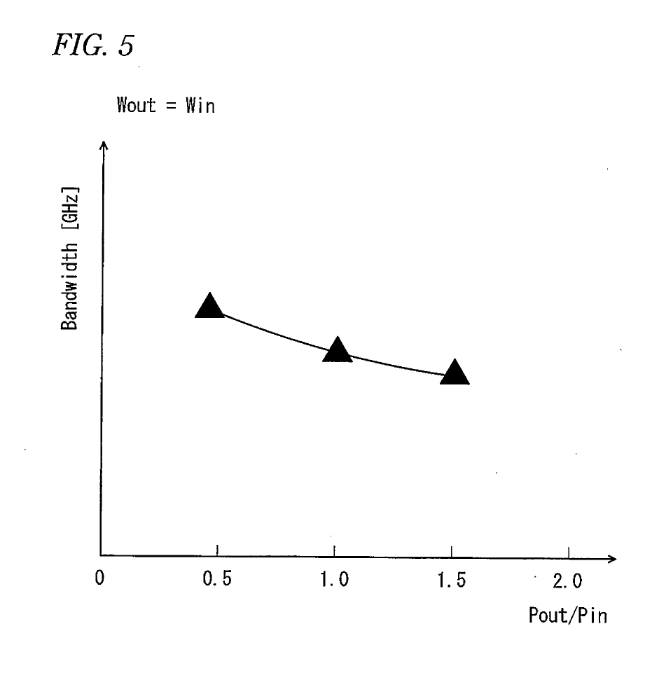

Next, the bandwidth characteristic of the transmission lines having the interleaved structure according to the embodiment will be described with reference to FIGS. 4 and 5. FIG. 4 is an exemplary graph of a bandwidth characteristic of transmission lines in which interleaved conductor patterns according to the embodiment are formed according to a first forming condition. FIG. 5 is an exemplary graph of a bandwidth characteristic of transmission lines in which interleaved conductor patterns according to the embodiment are formed according to a second forming condition.

FIG. 4 shows a bandwidth characteristic simulation result of transmission lines in which the widths of the conductor patterns and the gap lengths between the adjacent conductor patterns are set according to the first forming condition. FIG. 4 corresponds to a case that the outside conductor pattern width Wout and the inside conductor pattern width Win satisfy a relationship Wout<Win (first forming condition). FIG. 4 shows results of calculations of the transmission line bandwidth when the ratio of the outside pitch Pout to the inside pitch Pin is varied approximately in a range of 0.5 to 1.5 under the first forming condition. Not only do Wout and Win satisfy the first forming condition Wout<Win, but also they have certain fixed values.

Where the first forming condition is satisfied, the transmission line bandwidth increases as the ratio Pout/Pin increases from 0.5 to 1.5. That is, the bandwidth characteristic of the transmission lines is able to be improved by setting the ratio Pout/Pin larger than “1” (i.e., establishing a relationship Pout>Pin) while Wout and Win are kept constant. Conversely, the transmission line bandwidth is able to be narrowed and the bandwidth characteristic of the transmission lines is able to be degraded by setting the ratio Pout/Pin smaller than “1” (i.e., establishing a relationship Pout<Pin) while Wout and Win are kept constant.

FIG. 5 shows a bandwidth characteristic simulation result of transmission lines in which the widths of the conductor patterns and the gap lengths between the adjacent conductor patterns are set according to the second forming condition. FIG. 5 corresponds to a case that the outside conductor pattern width Wout and the inside conductor pattern width Win satisfy a relationship Wout=Win (first forming condition). FIG. 5 shows results of calculations of the transmission line bandwidth when the ratio of the outside pitch Pout to the inside pitch Pin is varied approximately in a range of 0.5 to 1.5 under the second forming condition. Not only do Wout and Win satisfy the second forming condition Wout=Win, but also they have certain fixed values.

Where the second forming condition is satisfied, the transmission line bandwidth increases as the ratio Pout/Pin decreases from 1.5 to 0.5. That is, the bandwidth characteristic of the transmission lines is able to be improved by setting the ratio Pout/Pin smaller than “1” (i.e., establishing a relationship Pout<Pin) while Wout and Win are kept constant. Conversely, the transmission line bandwidth is able to be narrowed and the bandwidth characteristic of the transmission lines is able to be degraded by setting the ratio Pout/Pin larger than “1” (i.e., establishing a relationship Pout>Pin) while Wout and Win are kept constant.

As described above, the bandwidth characteristic of transmission lines is able to be adjusted by setting the widths of conductor patterns according to a prescribed condition and setting the gap lengths of adjoining conductor patterns at different lengths arbitrarily. Therefore, the interleaved structure according to the embodiment is able to properly control the bandwidth characteristic of transmission lines having a wiring structure that each of transmission lines for differential signals branches off into plural lines.

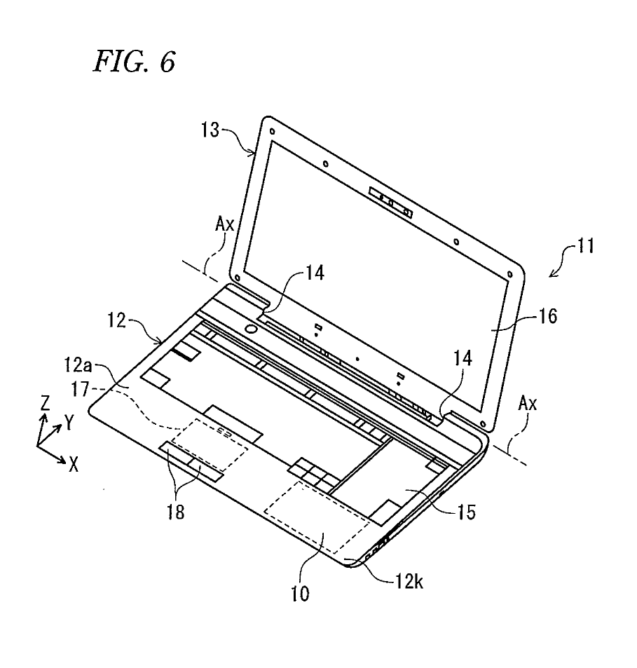

FIG. 6 is an exemplary perspective view of a notebook personal computer (hereinafter referred to as “notebook PC”) 11 which is an electronic apparatus including the data recording device according to the embodiment of the invention.

As shown in FIG. 6, the notebook PC 11 according to the embodiment includes a main body unit 12 which is equipped with a keyboard 15 etc. and a display unit 13 which is equipped with a display panel 16 and attached to the main body unit 12 so as to be able to be opened and closed with respect to it. End portions of the main body unit 12 and the display unit 13 are connected to each other by hinge mechanisms 14 so as to be rotatable with respect to each other around a rotation axis Ax between an open state and a closed state.

For the sake of convenience, the following directions are defined based on a state that the notebook PC 11 is in use. The X direction is defined as the width direction of the main body unit 12 (right-left direction), the Y direction is defined as the depth direction of the main body unit 12 as viewed from the user (front-rear direction), and the Z direction is defined as the thickness direction of the main body unit 12 (top-bottom direction). The X, Y, and Z axes, which are reference axes of the respective directions, are perpendicular to each other. In the following description, the front side and the rear side are defined as the user's side and the deep side, respectively, in the depth direction (Y direction). The top side and the bottom side are defined as the front surface side and the back surface side in the thickness direction (Z direction).

The main body unit 12 has a rectangular casing 12a. Input operation modules such as the keyboard 15, a pointing device 17, and click buttons 18 are provided in the main body unit 12 so as to be exposed in the top of the casing 12a. Only part of the keys of the keyboard 15 are shown in FIG. 6. The casing 12a has a palm rest 12k on the front side of the keyboard 15.

In the main body unit 12, a main circuit board, an optical disc device (ODD), the data recording device 10, etc. are housed in the casing 12a. Although in the embodiment the data recording device 10 is disposed under the palm rest 12k, the position of the data recording device 10 is not limited to that position. In the data recording device 10, a signal is transmitted by the interleave transmission lines which are the important feature of the embodiment.

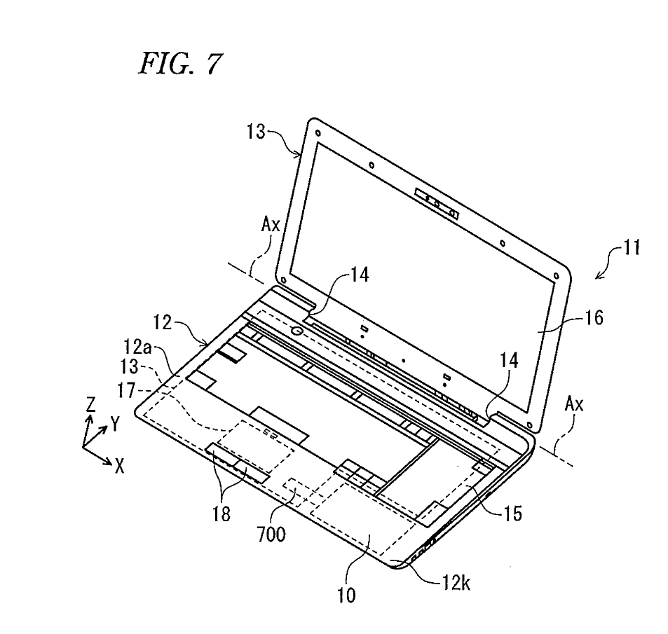

As shown in FIG. 7, the data recording device 10 is connected to the main circuit board 13 by an FPC 700 and performs a communication that complies with the SATA standard with the host system 100 which is provided on the main circuit board 13. The interleave transmission lines which are the important feature of the embodiment are able to be applied to the FPC 700.

The embodiment is also directed to the notebook PC which is an electronic apparatus to which the configuration of the embodiment is applied. However, the configuration of the embodiment may also be applied to other electronic apparatus such as a portable mobile terminal apparatus and a mobile phone.

As described above, in the embodiment, in the HDD 10, an electrical signal of information to be recorded on the magnetic disk 1 is transmitted as differential signals including a positive signal and a negative signal. Each of transmission lines for the positive signal and the negative signal branches off into plural lines and the branch lines for the positive signal and the branch lines for the negative signal are interleaved, which is called the interleaved structure. Not only do the transmission lines have the interleaved structure, but also the gap lengths between the adjoining conductor patterns and the widths of the respective conductor patterns are set according to a certain condition. With these configuration, the embodiment makes it possible to properly control the bandwidth characteristic of the wires with respect to the transmission lines for an electrical signal. Therefore, in the data recording device according to the embodiment, the bandwidth characteristic of the wires is able to be controlled properly in the wiring structure in which each of transmission lines for differential signals branches off into plural lines.

The invention is not limited to the above embodiment and various changes, modifications, etc. are possible without departing from the spirit and scope of the invention.

And various inventions can be conceived by properly combining plural configuration elements disclosed in the embodiment. For example, several ones of the configuration elements of the embodiment may be omitted.

What is claimed is:

1. A wiring structure comprising:
a plurality of positive signal wires configured to transmit a positive signal of differential signals; and
a plurality of negative signal wires configured to transmit a negative signal of the differential signals,
wherein the plurality of positive signal wires and the plurality of negative signal wires are interleaved,
wherein a first gap length and a second gap length are substantially different from each other, where the first gap length is a gap length between a first wire being an outermost wire among the plurality of positive signal wires and the plurality of negative signal wires and a first adjacent wire that is adjacent to the first wire, where the second gap length is a gap length between a second wire that is located inside among the plurality of positive signal wires and the plurality of negative signal wires and a second adjacent wire that is adjacent to the second wire, and
wherein the second wire and the second adjacent wire are different from the first wire.

2. The wiring structure of claim 1,
wherein the first wire comprises a third wire and a fourth wire, and
wherein a ratio of a third gap length to the second gap length is equal to a ratio of a fourth gap length to the second gap length, the third gap length being a gap length between the third wire and a third adjacent wire that is adjacent to the third wire, the fourth gap length being a gap length between the fourth wire and a fourth adjacent wire that is adjacent to the fourth wire.

3. The wiring structure of claim 1, wherein the number of the plurality of positive signal wires and the number of the plurality of negative signal wires are respectively larger than or equal to 2.

4. The wiring structure of claim 1, wherein the number of the plurality of positive signal wires is equal to the number of the plurality of negative signal wires.

5. The wiring structure of claim 1, wherein the first gap length is greater than the second gap length where a width of the first wire is narrower than a width of the second wire.

6. The wiring structure of claim 1, wherein the first gap length is smaller than the second gap length where the first wire is substantially as wide as the second wire.

7. A data recording device comprising:
conductor patterns configured to transmit a signal for data recording on a magnetic disk; and
a suspension comprising the conductor patterns on a side thereof,
wherein the conductor patterns comprise a wiring structure comprising:
a plurality of positive signal wires configured to transmit a positive signal of differential signals; and
a plurality of negative signal wires configured to transmit a negative signal of the differential signals,
wherein the plurality of positive signal wires and the plurality of negative signal wires are interleaved,
wherein a first gap length and a second gap length are substantially different from each other, where the first gap length is a gap length between a first wire being an outermost wire among the plurality of positive signal wires and the plurality of negative signal wires and a first adjacent wire that is adjacent to the first wire, where the second gap length is a gap length between a second wire that is located inside among the plurality of positive signal wires and the plurality of negative signal wires and a second adjacent wire that is adjacent to the second wire, and
wherein the second wire and the second adjacent wire are different from the first wire.

8. The data recording device of claim 7,
wherein the first wire comprises a third wire and a fourth wire, and
wherein a ratio of a third gap length to the second gap length is equal to a ratio of a fourth gap length to the second gap length, the third gap length being a gap length between the third wire and a third adjacent wire that is adjacent to the third wire, the fourth gap length being a gap length between the fourth wire and a fourth adjacent wire that is adjacent to the fourth wire.

9. The data recording device of claim 7, wherein the number of the plurality of positive signal wires and the number of the plurality of negative signal wires are respectively larger than or equal to 2.

10. The data recording device of claim 7, wherein the number of the plurality of positive signal wires is equal to the number of the plurality of negative signal wires.

11. The data recording device of claim 7, wherein the first gap length is greater than the second gap length where a width of the first wire is narrower than a width of the second wire.

12. The data recording device of claim 7, wherein the first gap length is smaller than the second gap length where the first wire is substantially as wide as the second wire.

13. An electronic apparatus comprising:
a data recording device; and
a casing configured to house the data recording device,
wherein the data recording device comprises,
conductor patterns configured to transmit a signal for data recording on a magnetic disk; and
a suspension comprising the conductor patterns on a side thereof,
wherein the conductor patterns comprise a wiring structure comprising:
a plurality of positive signal wires configured to transmit a positive signal of differential signals; and
a plurality of negative signal wires configured to transmit a negative signal of the differential signals,
wherein the plurality of positive signal wires and the plurality of negative signal wires are interleaved,
wherein a first gap length and a second gap length are substantially different from each other, where the first gap length is a gap length between a first wire being an outermost wire among the plurality of positive signal wires and the plurality of negative signal wires and a first adjacent wire that is adjacent to the first wire, where the second gap length is a gap length between a second wire that is located inside among the plurality of positive signal wires and the plurality of negative signal wires and a second adjacent wire that is adjacent to the second wire, and
wherein the second wire and the second adjacent wire are different from the first wire.

14. The electronic apparatus of claim 13,
wherein the first wire comprises a third wire and a fourth wire, and
wherein a ratio of a third gap length to the second gap length is equal to a ratio of a fourth gap length to the second gap length, the third gap length being a gap length between the third wire and a third adjacent wire that is adjacent to the third wire, the fourth gap length being a gap length between the fourth wire and a fourth adjacent wire that is adjacent to the fourth wire.

15. The electronic apparatus of claim 13, wherein the number of the plurality of positive signal wires and the number of the plurality of negative signal wires are respectively larger than or equal to 2.

16. The electronic apparatus of claim 13, wherein the number of the plurality of positive signal wires is equal to the number of the plurality of negative signal wires.

17. The electronic apparatus of claim 13, wherein the first gap length is greater than the second gap length where a width of the first wire is narrower than a width of the second wire.

18. The electronic apparatus of claim 13, wherein the first gap length is smaller than the second gap length where the first wire is substantially as wide as the second wire.
